(19) United States
(12) Patent Application Publication
(10) Pub. No.: US 2012/0053036 A1
(43) Pub. Date: Mar. 1, 2012

(54) FOLDER GLUER

(75) Inventors: DIRK BRUNS, Krefeld (DE); WOLFGANG DIEHR, Grevenbroich (DE); UWE HARTSTOCK, Nettetal (DE); SEDAT PADAR, Koeln (DE); FRANK SCHMID, Krefeld (DE)

(73) Assignee: HEIDELBERGER DRUCKMASCHINEN AG, HEIDELBERG (DE)

(21) Appl. No.: 13/222,085

(22) Filed: Aug. 31, 2011

(30) Foreign Application Priority Data
Aug. 31, 2010 (DE) 10 2010 036 015.5

(51) Int. Cl. B31B 1/62

(52) U.S. Cl. 493/128

(57) ABSTRACT

A folder gluer includes several processing modules which are disposed in series and are each equipped with a transport device. The transport device includes at least one upper conveying device and one lower conveying device with conveying elements that contact each other. At least one of the upper and/or lower conveying devices is divided and is formed of at least two conveying devices that are at a distance from each other in a conveying direction. At least one of the conveying devices is connected to a drive.

### CROSS-REFERENCE TO RELATED APPLICATION

This application claims the priority, under 35 U.S.C. §119, of German Patent Application DE 10 2010 036 015.5, filed Aug. 31, 2010; the prior application is herewith incorporated by reference in its entirety.

### BACKGROUND OF THE INVENTION

### Field of the Invention

The invention relates to a folder gluer or folding-box gluer including several processing units of modular construction disposed in series for producing folding boxes from folding box blanks. Each of the processing units or modules includes a respective transport device having at least one upper and one lower conveying device. The conveying devices include conveying elements contacting each other for transporting the box blanks in a conveying direction between the upper and lower conveying devices.

Folder gluers of that general type for producing folding boxes out of folding box blanks are known to include at least the following processing units of modular construction:

a feeder which successively separates the blanks to be processed from a stack at a high speed and feeds them individually to a downstream first processing unit,

an application unit for applying a strip of an adhesive, generally glue, to the folding flaps that are to be glued, and

a folding unit in which blank portions that have been provided with glue are bent at a 180° angle to create an adhesive bond and thus are folded.

The folding unit is usually followed by a so-called transfer unit in which the boxes can be counted, marked, and discharged if they are defective.

The next unit is usually a pressing unit at an inlet of which a shingled stream of folded blanks is formed, which is then subjected to pressure for a certain period of time to bond the two blanks at the glue line.

The individual processing units include driven conveying elements for transporting the folding box blanks. Such conveying elements may, for instance, be formed of an upper conveying belt and a lower conveying belt disposed on a side of the machine. The lower conveying belt is guided in a roller cheek and the upper conveying belt is guided in a roller track. The conveying belts are configured to be transversely adjustable and can thus be adapted to the respective size and format of the folding box blanks. The blanks are transported between the upper and lower conveying belts with their printed side facing downward. A folder gluer of that type is known from German Published Patent Application DE 10 2004 022 344 A1.

However, in some applications, the continuous lower conveying belts are an inconvenience because, for instance, a line camera may be provided to record a picture across the entire width of the blank for quality control purposes. It is known to subdivide the lower conveying belt in order to provide a gap for camera inspection across the entire width of the blank, while the upper conveying belt remains continuous. For structural reasons, the rear lower conveying belt is difficult to drive. In some applications, however, the upper conveying belt or even the upper conveying belt and the lower conveying belt may be subdivided.

### SUMMARY OF THE INVENTION

It is accordingly an object of the invention to provide a folder gluer or folding-box gluer, which overcomes the hereinafore-mentioned disadvantages of the heretofore-known devices of this general type and which has transport devices for transporting box blanks in a simple and reliable way, even across conveying gaps, either within a module or between two modules.

With the foregoing and other objects in view there is provided, in accordance with the invention, a folder gluer comprising several processing modules disposed in line for producing folding boxes out of folding box blanks. Each processing module has a transport device including at least one upper and one lower conveying device having conveying elements which contact each other. The box blanks are transported between these upper and lower conveying devices. In order to reliably bridge a gap within the module or between two modules, at least one of the upper and/or lower conveying devices is divided and is formed of at least two conveying devices spaced apart from each other. At least one of the conveying devices is connected to a drive to ensure that the folding box blanks are securely transported even across the gap.

In accordance with a concomitant preferred feature of the invention, the spacing between the divided conveying devices is variable. This is particularly easy to implement in embodiments that include tapes, belts, rollers, suction rollers, suction plates, or suction belts as the conveying elements.

Other features which are considered as characteristic for the invention are set forth in the appended claims.

Although the invention is illustrated and described herein as embodied in a folder gluer or folding-box gluer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of individual processing units in one example of a folder gluer;

FIG. 2 is a perspective view of a continuous transport device according to the prior art in a processing unit of a folder gluer;

FIGS. 3A-3E are side-elevational views of transport devices according to the invention constructed as belt conveyors;

FIG. 4 is a perspective view of an alternative transport device according to the invention including a suction belt;

FIGS. 5A and 5B are side-elevational views of alternative transport devices according to the invention including transport rollers;

FIGS. 6A and 6B are side-elevational views of alternative transport devices according to the invention including transport balls;

FIG. 7 is an enlarged, side-elevational view of alternative transport devices according to the invention including a suction roller; and

FIGS. 8 and 8A are respective side-elevational and perspective views of alternative transport devices according to the invention including a suction plate.

### DETAILED DESCRIPTION OF THE INVENTION

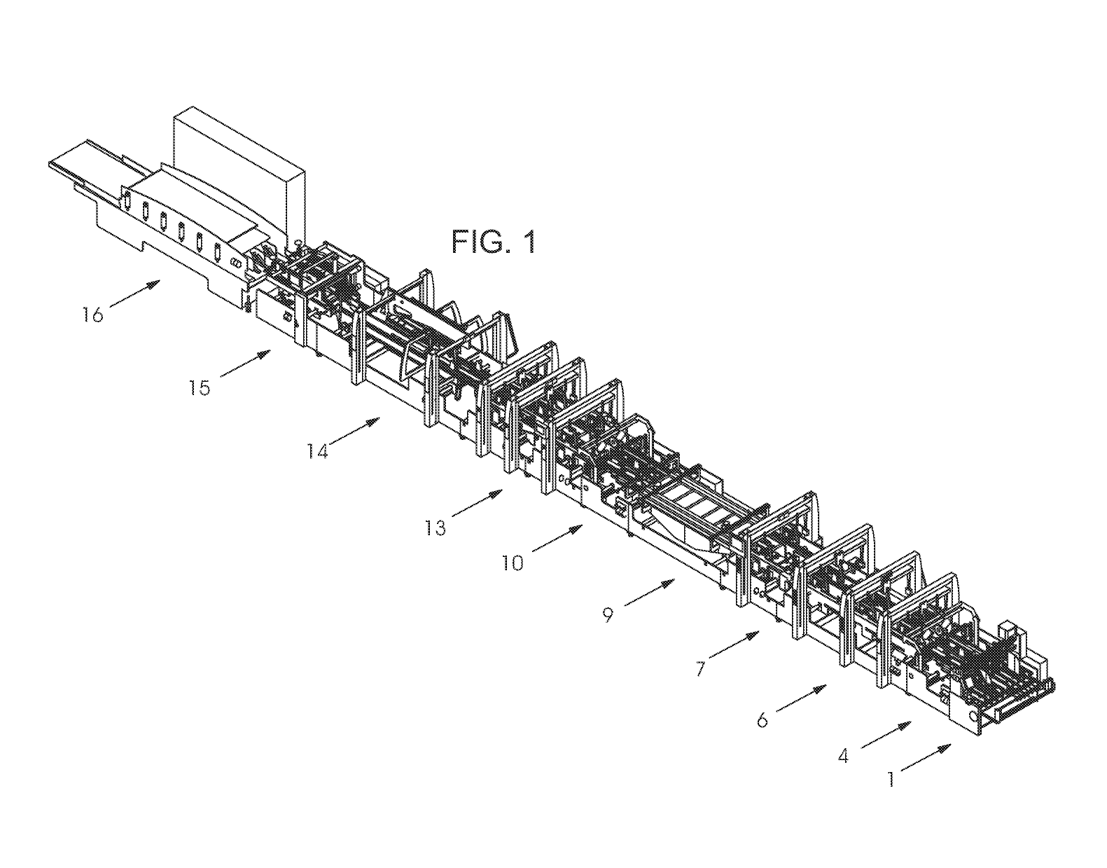

Referring now in detail to the figures of the drawings and first, particularly, to FIG. 1 thereof, there are seen examples of individual processing units, stations or modules in a folder gluer of the aforementioned type, in which all exemplary embodiments include several processing units, stations or modules through which folding box blanks pass in succession.

The folder gluer starts in the lower right-hand corner of FIG. 1. The first unit is a feeder 1 which successively separates individual blanks to be processed from a stack at a high speed to feed them individually to a downstream processing unit. The feeder 1 is followed by an alignment unit 4 in which the blanks are individually aligned against a lateral stop. Transversely positionable machine components in the form of two belt pairs are used as conveying elements to guide the blanks through the alignment device. Actuating drives are provided to move the components in the transverse direction.

The next units are a prefolding unit 6 and a first folding module 7. The blanks are guided through both the prefolding unit 6 and the folding unit 7 by transversely positionable machine components in the form of belt pairs that act as conveying elements. An actuating drive is provided to move the conveying elements in the transverse direction to position them as needed for the specific blank type to be processed.

The folding module 7 is followed by a rotating unit 9. The rotating unit 9 rotates the blanks through a 90° angle about a vertical axis. For this purpose, it includes two parallel conveying sections that are disposed adjacent each other. The speeds of the two conveying sections can be adjusted independently of each other. During transport, the blanks lie flat on the two conveying sections and are thus rotated when the two conveying sections move at different speeds. The two conveying sections include driven rollers as conveying elements.

As the blanks exit the rotating unit 9, they are fed to a further alignment unit 10 which corresponds to the alignment unit provided downstream of the feeder 1, from a structural point of view. Thus, it likewise includes transversely positionable machine components, namely conveying belt pairs, as conveying elements.

A following processing unit 13 is used to carry out processing operations as required for the type of box to be created. For example, further crease lines may be prefolded or special folds may be made. The conveying elements that guide the blanks through the processing unit 13 are likewise belt pairs that can be positioned in the transverse direction through the use of actuating drives.

In a following folding unit 14, blank sections that have been provided with a line of glue are folded at a 180° angle. The folding unit 14 includes belt pairs as conveying elements and a glue application unit. Actuating drives are provided to move the belt pairs into a transverse position as a function of the type of blank to be processed. The folding unit is followed by a transfer unit 15 which ensures that the blanks with their glue lines that have not yet been bonded are in accurate alignment when they are fed to a downstream accumulation and pressure device 16. In the accumulation and pressure device 16, a shingled stream of folded blanks is formed and is then subjected to pressure between conveying pressure belts for a certain amount of time for the glue lines to bond. The transfer unit likewise includes belt pairs that can be adjusted in the transverse direction through the use of actuating drives.

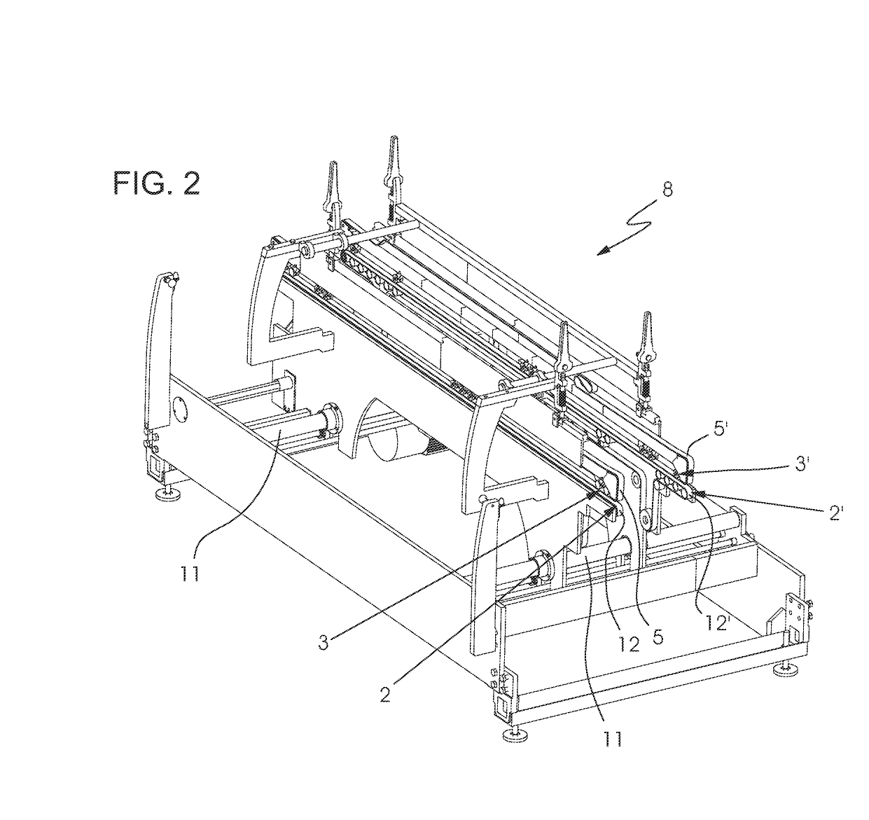

FIG. 2 illustrates an example of a transport device 8 including respective upper left-hand and upper right-hand conveying devices 3, 3′ and respective lower left-hand and lower right-hand conveying devices 2, 2′ and which is constructed in the given example as a belt conveyor including suitable conveying belts as conveying elements 5, 5′, 12, 12′. The conveying devices 3, 3′, 2, 2′ are supported on round crossbars 11 and are thus adjustable to the respective width of the box blanks.

In the following diagrammatic representation, only one upper and one lower conveying device are shown for reasons of clarity.

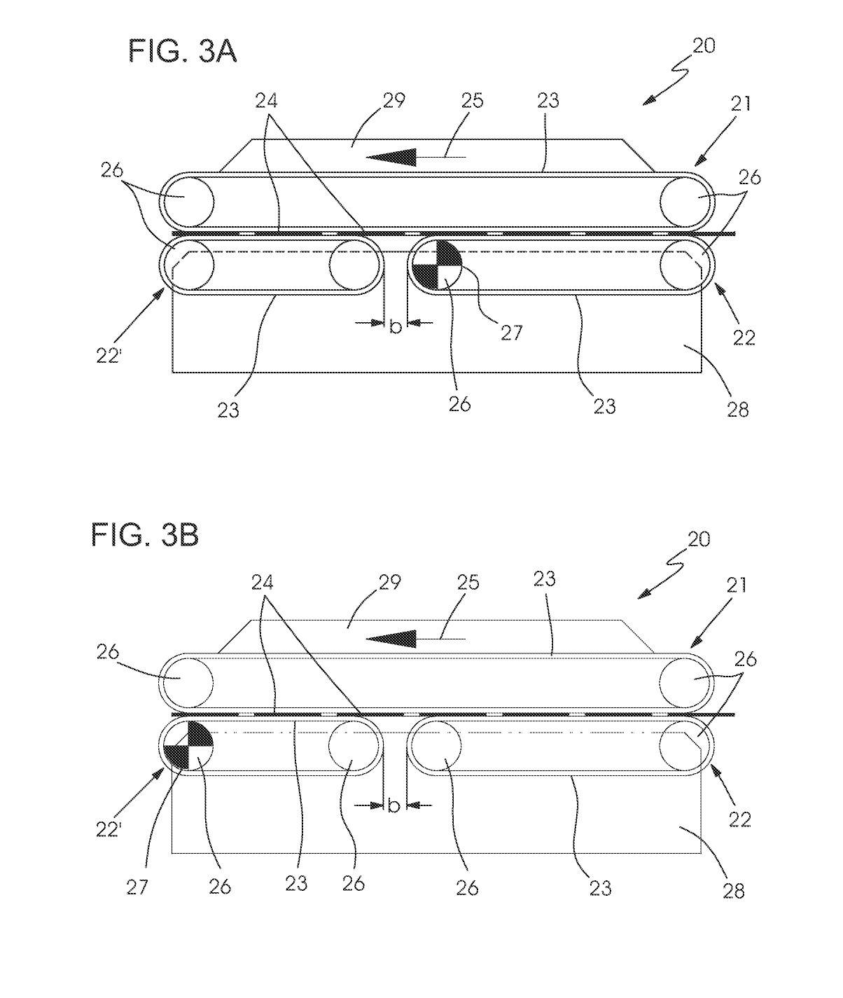

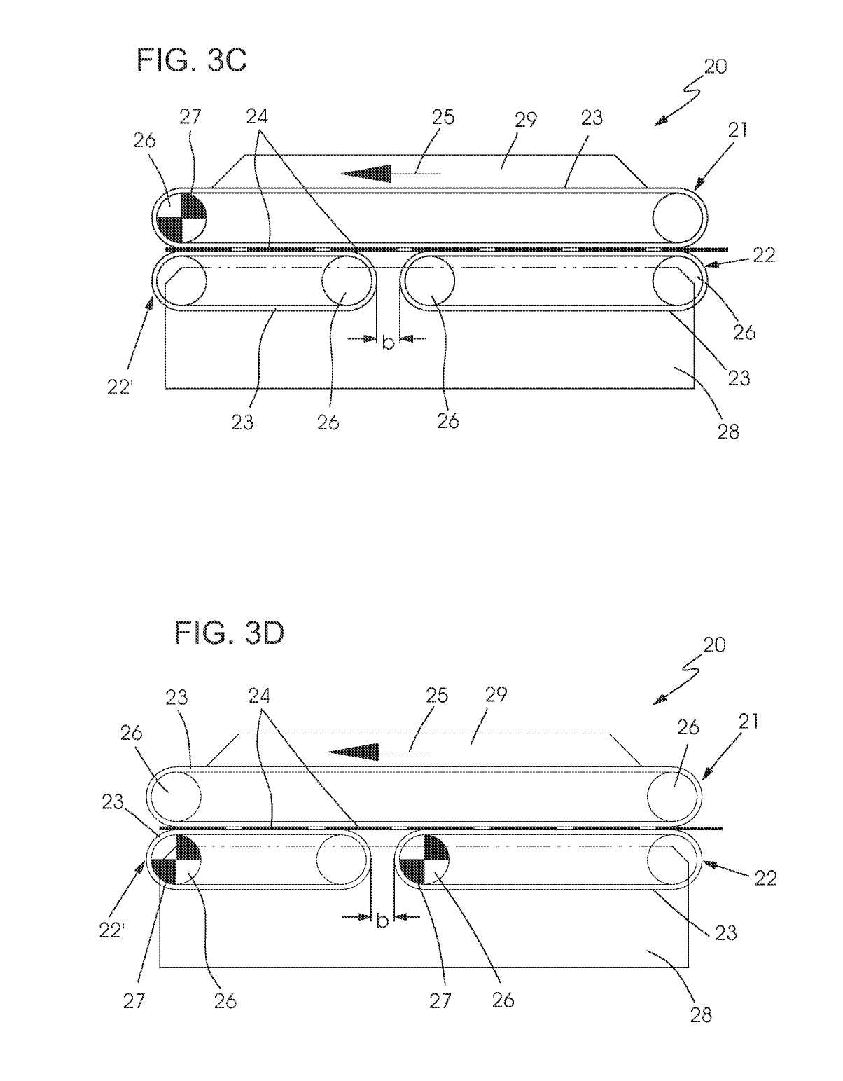

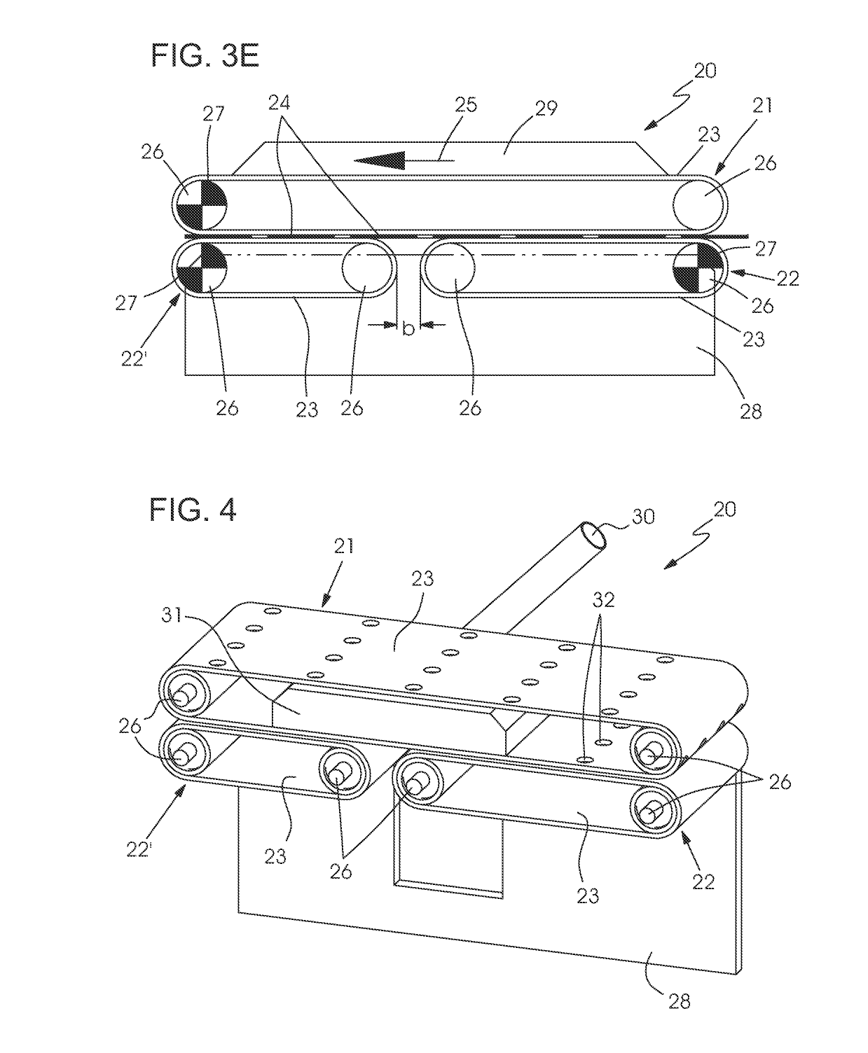

FIGS. 3A to 3E illustrate various transport devices 20 constructed in accordance with the invention as belt conveyors. FIG. 3A illustrates one possible way of reliably transporting a folding box blank 24 across a gap formed between two lower conveying devices 22, 22′ and having a width b. The transport device 20 according to the invention is formed of an upper conveying device 21, which includes a conveying element 23 embodied as a transport belt guided by deflection rollers 26. As viewed in a conveying direction 25, the lower conveying device of the transport device includes a first lower conveying device 22 and a second lower conveying device 22′ disposed at a distance b from the first conveying device 22. The two lower conveying devices 22, 22′ likewise include transport belts guided by deflection rollers 26 as the conveying elements 23. The conveying elements 23 of the upper and lower conveying devices 21, 22, 22′ contact each other to clamp the folding box blank to be conveyed. As is known in the art, the upper conveying device is supported in a roller track 29 and the lower conveying devices are supported in roller cheeks 28.

The second deflection roller 26 of the first lower conveying device 22, as viewed in the conveying direction 25, is connected to a drive which is illustrated by dark triangular shading. Thus, it acts as a drive roller 27 for the conveying elements 23 of the lower conveying device 22. When the drive roller 27 is rotated in a counter-clockwise direction, the conveying element 23 of the lower conveying device 22 is set in a counterclockwise motion. Since the upper strand of the conveying element 23 of the lower conveying device 22 contacts the lower strand of the conveying element 23 of the upper conveying device 21, the conveying element 23 of the upper conveying device 21 starts to move in a clockwise direction due to friction between the two conveying elements. In an analogous way, the conveying element 23 of the second lower conveying device 22′ as viewed in the conveying direction starts to move in a counterclockwise direction due to friction between the conveying elements 23 of the upper conveying device 21 and the second lower conveying device 22′. Thus, a folding box blank clamped between the conveying elements 23 is therefore conveyed in the conveying direction 25.

FIG. 3B illustrates an alternative transport device 20. In contrast to the transport device 20 shown in FIG. 3A, in FIG. 3B, it is the second deflection roller 26 of the second lower conveying device 22′, as viewed in the conveying direction 25, that is connected to a drive which is otherwise not illustrated in greater detail, thus acting as a drive roller 27. Therefore, the drive roller 27 drives the conveying element 23 of the second lower conveying device 22′, as viewed in the conveying direction 25. Consequently, the conveying element 23 of the upper conveying device 21 is driven by friction and in turn frictionally drives the conveying element 23 of the lower conveying device 22, as viewed in the conveying direction 25.

FIG. 3C illustrates another alternative transport device 20. As viewed in the conveying direction 25, in this embodiment, the second deflection roller 26 of the upper conveying device 21 is chosen as the drive roller. The lower conveying devices 22, 22′ are driven by friction as the conveying elements 23 contact each other.

FIG. 3D illustrates another alternative transport device 20. In accordance with this embodiment, as viewed in the conveying direction, the second deflection roller 26 of the first lower conveying device 22 as viewed in the conveying direction 25 and additionally the second deflection roller 26 as viewed in the conveying direction of the second lower conveying device 22′ as viewed in the conveying direction, are selected as the drive rollers 27. The upper conveying device 21 is driven by friction as the conveying elements 23 contact each other.

FIG. 3E illustrates another alternative transport device 20. In accordance with this embodiment, the upper conveying device 21 and the two lower conveying devices 22, 22′ are each driven by a respective drive roller 27.

The transport devices 20 shown in FIGS. 3A to 3E represent a reliable low-cost way of conveying folding box blanks across gaps within a module. The sizes of the gaps may vary as required.

The transport devices illustrated in the figures are to be understood as examples only. Various further alternatives are conceivable. Moreover, these drive concepts may not only be used to bridge gaps within a module. It is likewise possible to use these drive concepts to bridge gaps between two modules.

In the embodiments shown in FIGS. 3A to 3E, the conveying elements 23 are constructed as transport tapes or transport belts.

FIG. 4 illustrates an alternative configuration. In the illustrated transport device 20, the conveying element 23 for the upper conveying device 21 is a suction belt. The box blank is held against the suction belt by suction due to holes 32 formed in the suction belt. The holes 32 communicate with a suction box 31 that is connected to a vacuum source 30. As in the embodiments described above, transport is achieved by connecting at least one of the deflection rollers 26 of the upper conveying device 21 or of the two lower conveying devices 22, 22′ to a drive.

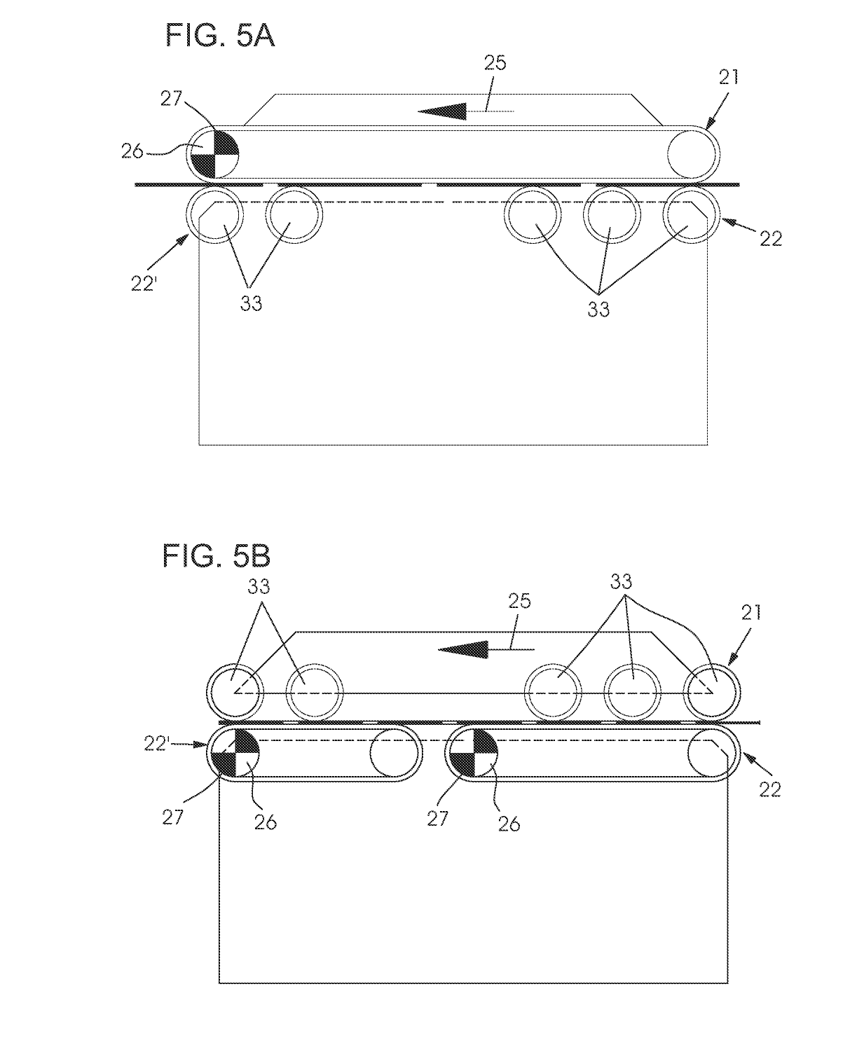

FIGS. 5A and 5B illustrate two further alternative embodiments. In FIG. 5A, the two lower conveying devices 22 and 22′ include rollers 33 as the conveying elements and the upper conveying device 21 is a belt conveyor with the second deflection roller 26, as viewed in the conveying direction, provided as the driven deflection roller. In FIG. 5B, the reverse is the case. The upper conveying device 21 includes rollers 33 as the conveying elements and the lower conveying devices 22, 22′ are respectively embodied as driven belt conveyors.

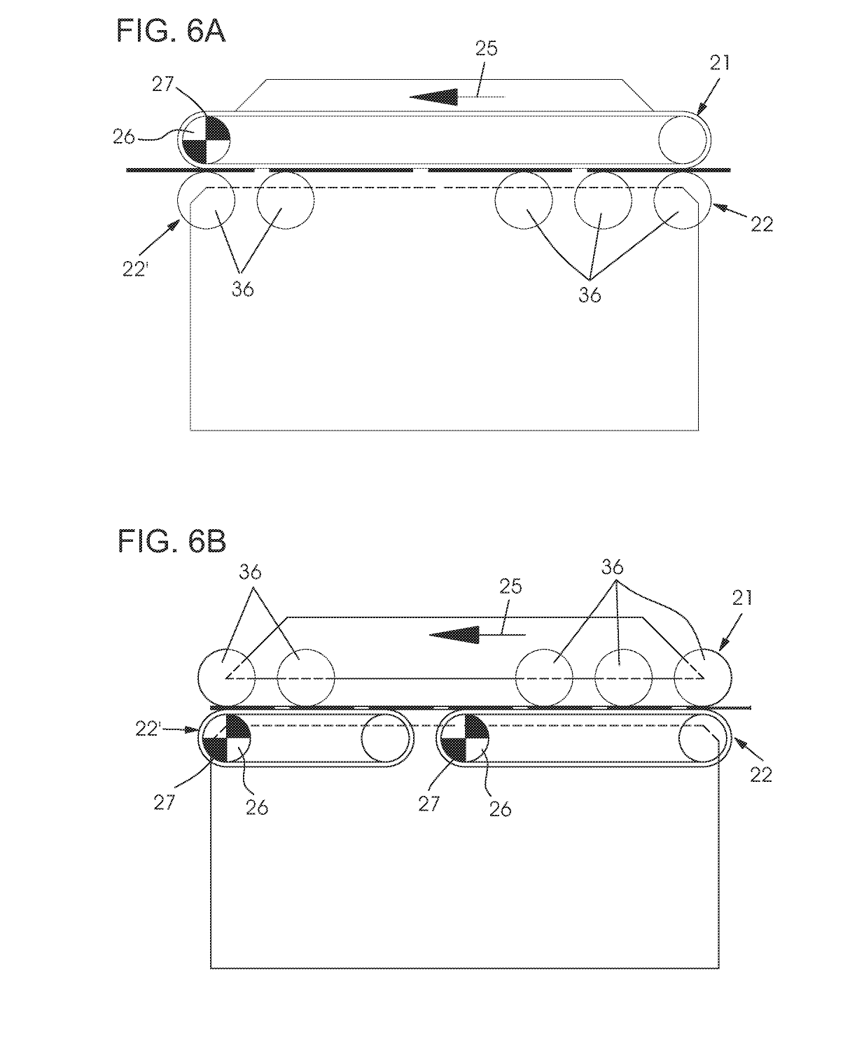

Two further alternative embodiments are shown in FIGS. 6A and 6B. In contrast to the embodiments shown in FIGS. 5A and 5B, the rollers 33 are replaced by balls 36 that are supported in an otherwise non-illustrated ball track.

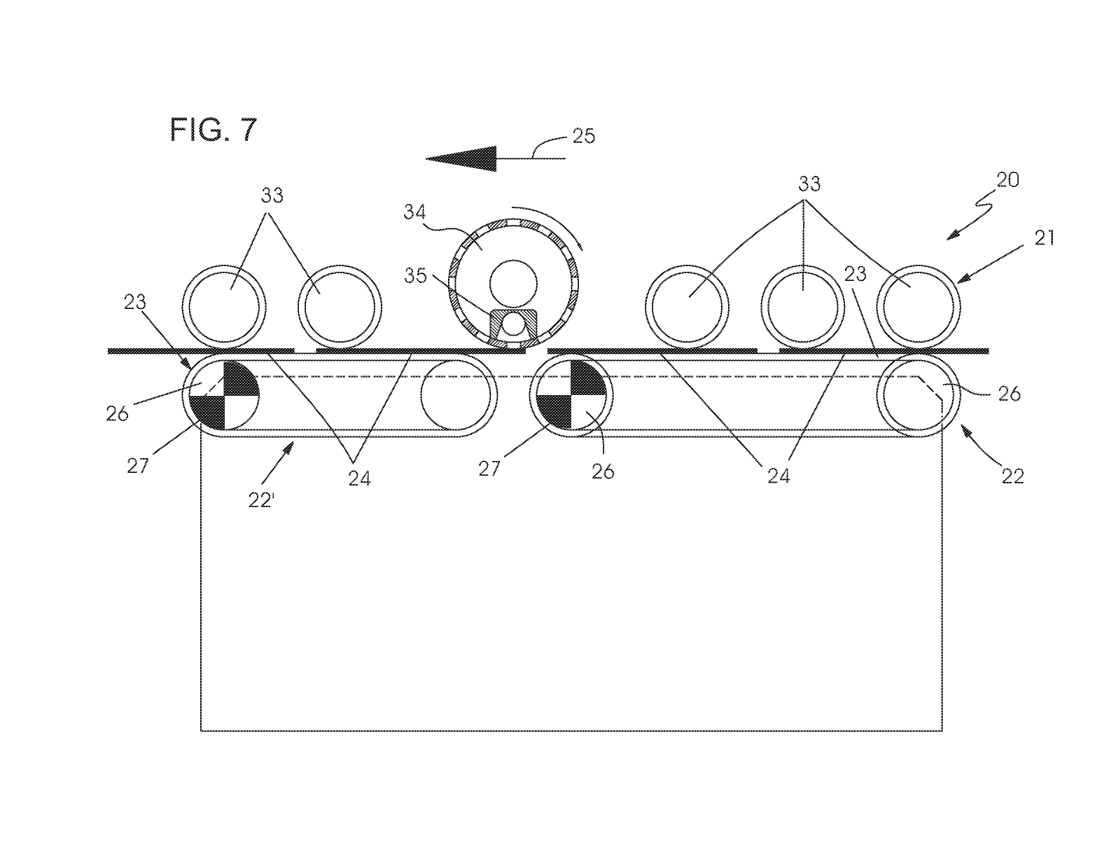

FIG. 7 illustrates another alternative embodiment. In this embodiment, the transport device 20 includes two driven lower conveying devices 22, 22′. The upper conveying device 21 is formed of rollers 33 and a suction roller 34 with a stationary suction head 35. The rotating suction roller 34 is located above a gap formed between the two lower conveying devices 22, 22′ that are disposed at a gap width or distance b apart from each other. The suction head 35 for attracting the folding box blanks 24 by suction is disposed in a hollow chamber of the suction roller 34. A suction region inside the roller is limited in the lower region, thus allowing the blank to be released as it leaves the gap. In a manner analogous to the alternatives shown in FIGS. 5B and 6B, the embodiment illustrated in FIG. 7 may likewise include balls 36 instead of rollers 33. Furthermore, the upper conveying devices upstream and downstream of the suction roller 34 may be conveying belts 23 having deflection rollers 26.

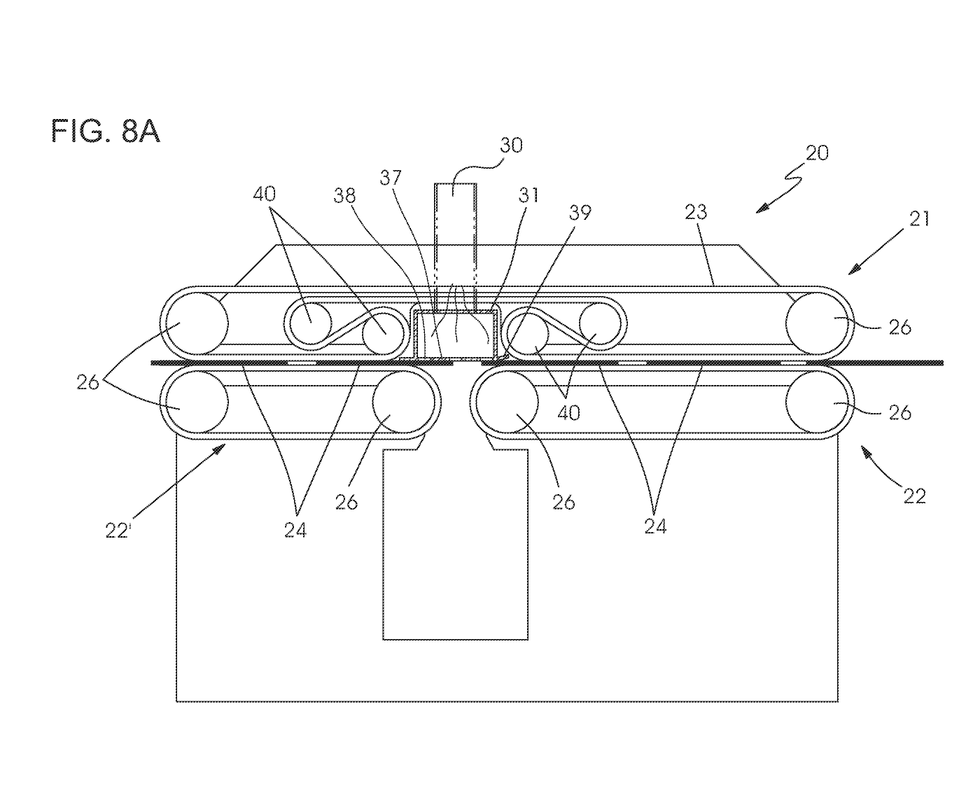

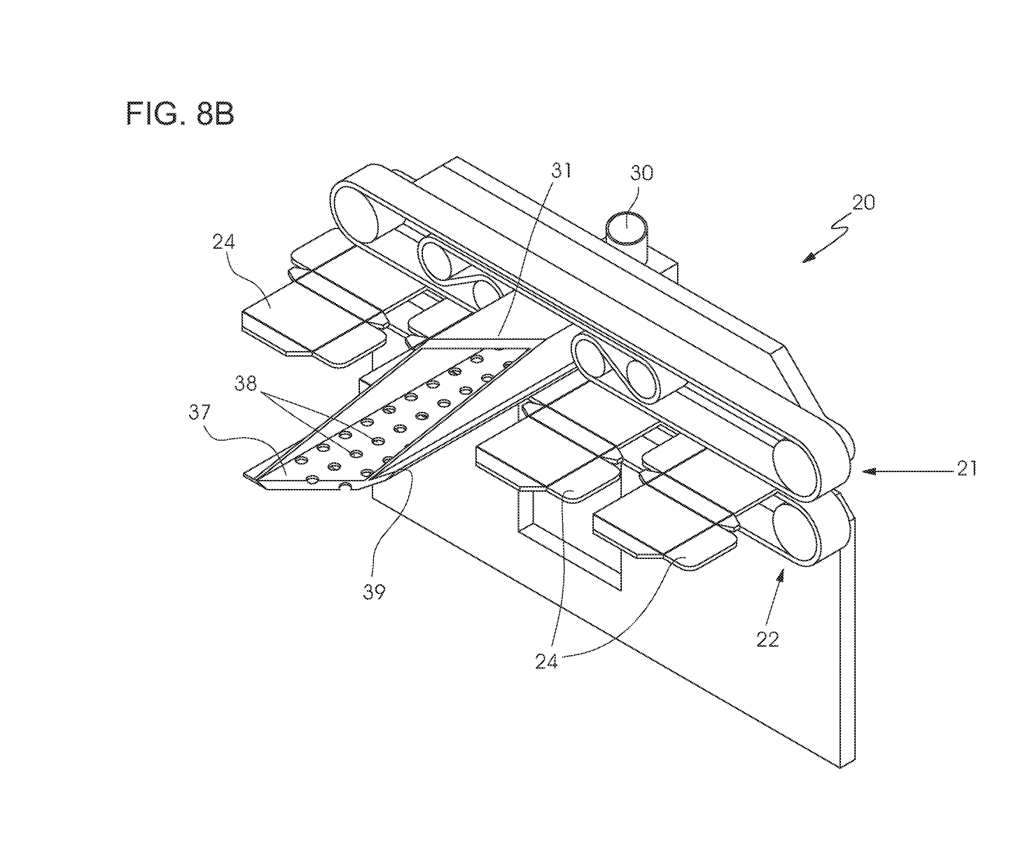

Another alternative embodiment is shown in FIGS. 8A and 8B. The illustrated transport device 20 includes a transport belt as the conveying element 23 for the upper conveying device 21. The conveying element 23 is guided by deflection rollers 26 and 40 in such a way that a gap is created to accommodate a suction box 31. In order to hold a box blank 24 by suction, holes 38 are formed in a suction plate 37, which may be a rigid suction plate. The holes 38 communicate with the suction box 31 which is connected to a vacuum source 30.

In addition, the transport device 20 includes two lower conveying devices 22, 22′ guided by deflection rollers 26. In this case, like the embodiments described above, the box blanks 24 are transported by connecting at least one of the deflection rollers 26 of the upper conveying device 21 or of the two lower conveying devices 22, 22′ to a drive. In order for the box blanks 24 to enter the area below the suction box 31 without disturbance, the suction box 31 may advantageously include an inlet aid 39.

In accordance with this embodiment, a gap has been created in the upper region to accommodate the suction box whereas the lower region includes a gap to accommodate a line camera or a processing tool.

1. A folder gluer, comprising:
a plurality of processing modules disposed in series for producing folding boxes from folding box blanks;
each of said processing modules including a respective transport device having at least one upper and at least one lower conveying device;
said conveying devices including conveying elements contacting each other for transporting the box blanks in a conveying direction between said upper and lower conveying devices;
at least one of said upper or lower conveying devices being divided and formed of at least two conveying devices disposed at a distance from each other in the conveying direction; and
a drive connected to at least one of said conveying devices.

2. The folder gluer according to claim 1, wherein said distance between said divided conveying devices in the conveying direction is variable.

3. The folder gluer according to claim 1, wherein said conveying elements of said conveying devices are constructed as at least one of transport belts or tapes or suction belts or a suction plate or rollers or balls or suction rollers.

4. The folder gluer according to claim 1, wherein:
said at least one lower conveying device includes first and second lower conveying devices disposed along the conveying direction and having respective first and second deflection rollers disposed along the conveying direction; and
said second deflection roller of said first lower conveying device is a drive roller connected to said drive for driving said conveying element of said first lower conveying device.

5. The folder gluer according to claim 1, wherein:
said at least one lower conveying device includes first and second lower conveying devices disposed along the conveying direction and having respective first and second deflection rollers disposed along the conveying direction; and
said second deflection roller of said second lower conveying device is a drive roller connected to said drive for driving said conveying element of said second lower conveying device.

6. The folder gluer according to claim 1, wherein:
said upper conveying device has first and second deflection rollers disposed along the conveying direction; and
said second deflection roller is a drive roller connected to said drive for driving said conveying element of said upper conveying device.

7. The folder gluer according to claim 1, wherein:
said at least one lower conveying device includes two lower conveying devices having respective first and second deflection rollers disposed along the conveying direction; and
said second deflection rollers of said two lower conveying devices are drive rollers connected to said drive for driving said conveying elements of said lower conveying devices.

8. The folder gluer according to claim 1, wherein:
said at least one lower conveying device includes first and second lower conveying devices disposed along the conveying direction and having respective first and second deflection rollers disposed along the conveying direction;
said upper conveying device has first and second deflection rollers disposed along the conveying direction; and
said first deflection roller of said first lower conveying device and said second deflection rollers of said upper conveying device and of said second lower conveying device are drive rollers connected to said drive for driving said conveying elements of said lower conveying devices and of said upper conveying device.
